(19) United States
(12) Patent Application Publication
(10) Pub. No.: US 2004/0078615 A1
(43) Pub. Date: Apr. 22, 2004

(54) Multi-module system, distribution circuit and their methods of operation

(75) Inventors: Aaron K. Martin, Hillsboro, OR (US); Stephen R. Mooney, Beaverton, OR (US)

Correspondence Address: MARGER JOHNSON & McCOLLOM, P.C., 1030 S.W. Morrison Street, Portland, OR, 97205, US

(73) Assignee: Intel Corporation (a Delaware Corporation), Santa Clara, CA (US)

(21) Appl. No.: 10/274,073

(22) Filed: Oct. 17, 2002

(51) Int. Cl. G06F 1/04

(52) U.S. Cl. 713/500

(57) ABSTRACT

A signal propagation system includes a plurality of memory modules that receive a clock signal from a system clock generator. A backplane has a first clock line that propagates a clock signal from the generator to a first memory module of the plurality of memory modules. The backplane may also include a second line that propagates a clock signal between the first and a second memory module of the plurality. The first memory module may include an onboard transmission line that propagates a clock signal between respective first and second clock lines of the backplane.

### BACKGROUND

Computers, processors and other data handling systems may comprise a number of modules that exchange a variety of signals therebetween. Some systems may comprise a plurality of memory modules for handling of data. As manufactures advance system architectures, they may incorporate more memory and may increase their operating speeds. Some system architectures may also incorporate pipelining procedures and circuitry that may improve performance levels by multiplexing or controlling the time placement of data signals into predetermined time slots relative to other address and control signals. Additionally, clock signals may be distributed across the system and may be used to affect the relative time placement of the various signals within the system. Conventionally, an edge (or edges) of a system clock signal may be used to trigger and synchronize transfers amongst the modules.

Referencing FIG. 1, for example, a conventional multi-module system 100 may comprise a plurality of memory modules 110A, 110B . . . disposed on backplane 120. Each memory module 110 may have an on-board clock line 140 for distributing a clock signal to a plurality of memory devices or chips 131,132,133 . . . of the memory module. For example, memory devices 131,132,133 may comprise synchronous DRAM devices that receive a clock signal for controlling when they decode address signals, transfer data or synchronize data burst intervals of a plurality of transfer cycles for a burst sequence. With a distributed clock, ideally, each memory device of a memory module may operate with similar timing relative to the other memory devices of the memory module.

At the system level, a system clock signal may be generated by clock generator 140 of, for example, a memory controller. Clock line 150 of backplane 120 may propagate the system clock signal from the memory controller to a plurality of memory modules 110A, 110B. . . . Tap lines 152A, 152B . . . may couple respective memory modules 110 to receive the clock signal of system clock line 150.

For a conventional system, the plurality of memory modules may comprise, for example, Dual In-line Memory Modules (DIMMs). A conventional DIMM may comprise a small circuit board that carries memory integrated circuits on both sides of the board. Within a system 100, a plurality of DIMM modules may be supported by backplane 120 and coupled to signal lines of the backplane. As shown in the illustrated conventional system of FIG. 1, backplane 120 may have a bus with a system clock line 150 for distributing the system clock signal to the plurality of DIMMs.

Recently, manufactures have been changing system architectures to include more memory of greater operating speeds. Accordingly, the number of memory modules 110 may increase as well as the length of system clock line 150 associated with distributing the system clock to the memory modules. The higher operating speeds may push the system clocks to higher frequencies. Such increase in frequency may be viewed as having the effect of further extending the relative lengths of the drop lines that couple to the system clock line.

A given length line may be understood to comprise an “effective length” quantified by a number of wavelengths of the system clock. Therefore, as a frequency of a system clock increases, its associated wavelength (λ=1/f) decreases and the effective length of the given length drop line may be understood to increase in direct relationship to the increase in the clock frequency.

Accordingly, as the frequency of the system clock increases and as the number of memory modules also increase, the drop lines of the conventional systems may be more likely to present stub reflections and attenuations to system line 150 so as to adversely affect the integrity thereof. These drop lines of the conventional system may also be more vulnerable to noise and jitter degradations as the system clock frequencies increase.

### BRIEF DESCRIPTION OF THE DRAWINGS

The present disclosure may be best understood with reference to the accompanying drawings, wherein:

FIG. 1 is a simplified schematic diagram representative of a conventional system for distributing a clock signal to a plurality of memory modules;

FIG. 2A is a simplified schematic diagram of a system to propagate a clock signal to a plurality of memory modules in accordance with an embodiment of the present invention;

FIG. 2B is a simplified schematic diagram representative of a launch associated with a medium transition within the distribution circuit of FIG. 2A;

FIG. 3 is a schematic diagram of a system that distributes a clock signal to a plurality of memory devices in accordance with another embodiment of the present invention;

FIG. 4 is a schematic diagram representative of an alternative memory module for a system of FIG. 3 in which a clock signal may be distributed outwardly to memory devices of a memory module in accordance with a further embodiment of the present invention; and

FIG. 5 is a schematic diagram representative of a system to distribute a clock signal to a plurality of memory devices in accordance with another embodiment of the present invention;

FIG. 6 is a schematic diagram representative of a system for distributing a clock signal to a plurality of memory devices in accordance with yet another embodiment of the present invention.

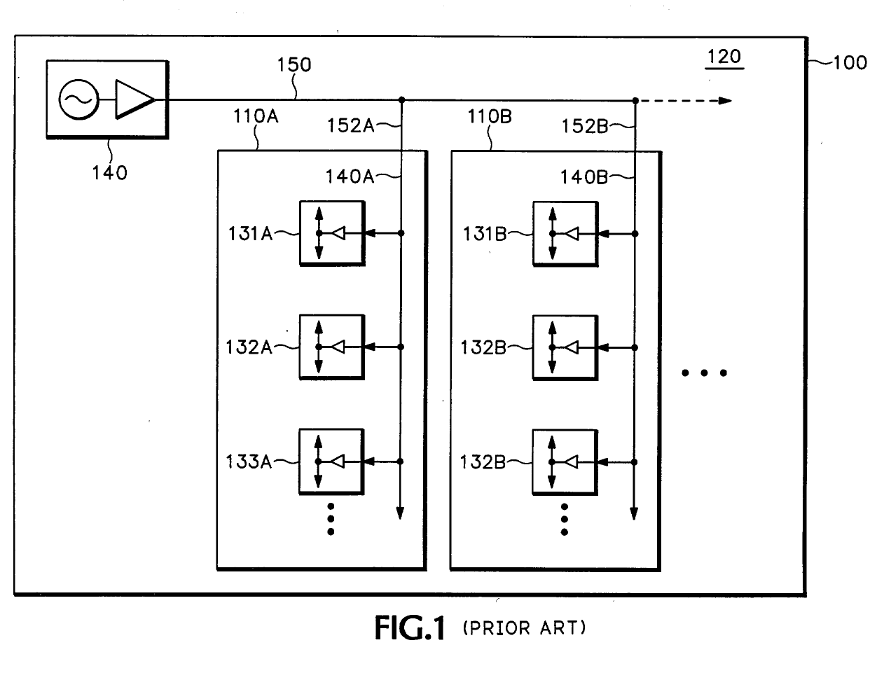

### DETAILED DESCRIPTION

In the following description, well-known circuits may be shown in block diagram form in order not to obscure description of embodiments of the present invention with unnecessary detail. Additionally, specific details of timing signals may be omitted where such details are not necessary to obtain a complete understanding of the embodiments of the present invention and are within the skills of persons of ordinary skill in the relevant art.

Reference may be made to the drawings, wherein elements depicted may not necessarily be shown to scale. Additionally, like or similar elements may be designated by the same reference numeral through the various figures.

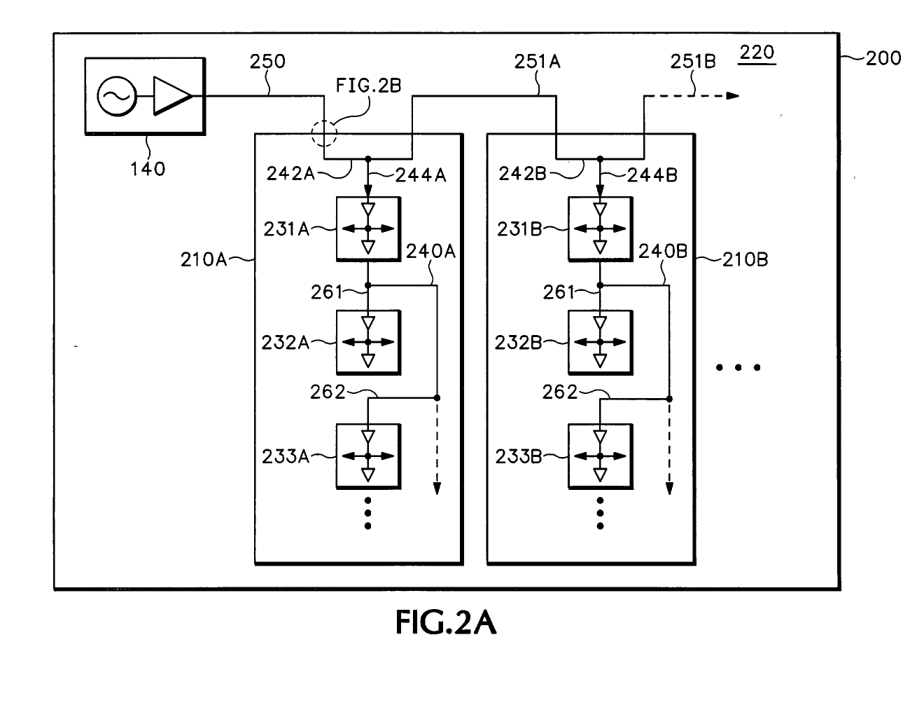

In accordance with an embodiment of the present invention, referencing FIG. 2A, a system 200 may comprise a transmission line circuit of a multi-tiered structure. The transmission line circuit may distribute a system clock signal to a plurality of memory devices of a plurality of memory modules. In one embodiment, clock generator 140 is part of a memory controller and may generate a clock signal that is to be distributed to a plurality of devices 231,232,233 . . . of system 200.

As used hereinafter, “devices” may refer to “memory devices,” which may comprise, in one embodiment, synchronous DRAM memory chips. However, it is understood that the scope of these embodiments of the present invention may encompasses other circuit devices operable to receive a system signal via a suitable transmission line.

Additionally, a “drop line” may be understood to reference a line that electrically couples into, e.g., the system clock line for propagating a portion of the system clock signal to memory devices of a memory module. Such “drop lines,” in accordance with one embodiment, may comprise tap lines 152 and associated clock lines 140 on-board memory modules.

In one embodiment, “memory modules” 210A, 210B may comprise Dual In-Line Memory Modules or DIMMs. The DIMMs may include a plurality of memory chips 231,232,233 . . . that may populate both sides of a small circuit board. The plurality of memory chips may receive a common clock signal. The memory modules may also couple the memory chips to receive signals of, e.g., data and address lines from a bus of a supporting backplane 220. Although, memory modules 210 may be described in a particular embodiment as comprising DIMMs; it is understood that other embodiments may comprise memory modules 210 of alternative forms, which may receive and distribute a system clock to a plurality of devices thereof. “Memory modules” 210 may also be referenced alternatively as “daughter boards” having a plurality of devices to receive a system clock signal.

Returning to the exemplary embodiment of FIG. 2A, clock generator 140 may drive a first link 250 of a first tier of transmission lines, which may be disposed on backplane 220. In this embodiment, transmission lines of the first tier 250,251A, 251B . . . comprise separate links that may be disposed in alternate and serial arrangement with respective transmission lines 242A, 242B . . . of the second tier. It may be understood that the second tier lines reside on-board respective memory modules 210A, 210B . . . . In this embodiment, the first tier of transmission lines may channel the system clock serially through the memory modules of a serial sequence.

In a particular embodiment, first memory module 210A may comprise an internal clock line 242A having a first end coupled to receive a system clock signal of system clock line 250. The internal clock line 242 may propagate a clock signal across the module from its first end to a second end that is coupled to a second transmission line of the first tier, such as link 251A of the system clock line. Transmission line 251A in this embodiment may be described as coupled to propagate a clock signal between first memory module 210A and second memory module 210B, and between associated transmission lines 242A, 242B of the second tier.

In this example, the transmission lines of the first and second tiers may be described as being disposed in alternate and serial arrangement with respect to each other, such as a sequence 250, 242A, 251A, 242B, 251B, etc., as shown in the embodiment of FIG. 2A. The serial string of inter-coupled first and second tier transmission lines may, thus, be viewed in their combination as a continuous, system level transmission line. Taps 244A, 244B . . . to drop lines may be coupled to the continuous system level transmission line.

In a particular embodiment, the characteristic impedance levels Zo of the second tier transmission lines correspond substantially to the characteristic impedance levels Zo′ of the first tier transmission line segments. For example, the characteristic impedance Zo of the first tier lines may comprise characteristic impedance levels of between 25 and 100 ohms as well as that of the second tier transmission lines. In one embodiment, the first and second tiers may comprise transmission lines of about 50 ohm characteristic impedance.

In FIG. 2A, the transmission lines are schematically illustrated in simplified fashion by simple segments. It will be understood, however, that the various segments actually comprise transmission line structures, e.g., of microstrip, strip line or similar geometry. For such transmission line structures, a signal conductor strip may be accompanied by an associated ground return. In a microstrip environment, the signal line may be understood to comprise a metal strip of a predetermined width that extends over a ground plane. For this example, the ground plane may serve as the return path that is to be associated with the signal path.

Further referencing FIGS. 2A, 2B, a launch 280 may comprise electrical coupling elements to transition propagation of a signal from a transmission media of the backplane 220 to that of the module board of memory module 210. In one embodiment, launch 280 may comprise a pair of pins that electrically interconnect the respective signal and return conductive members 152,153 and 140,141 of backplane 220 and module board 210 respectively. It may be further understood that the return pin may be located adjacent the pin for the signal lines. In further embodiments, the interconnects of launch 230 may comprise solder interconnects of, e.g., a ball grid array. Further, the launch may comprise multiple ground returns (not shown) per signal interconnect.

Continuing with further reference to FIG. 2A, memory module 210 may comprise buffer 231A to receive a clock signal from a second tier transmission line element 242A via tap 244A. In this embodiment, tap 244A may comprise a short length relative to the distance of the on-board transmission line 242A. For example, the distance of tap 244 may be less than about a few tens of mils, while the length of a second tier transmission line 242 may extend as long as 3-4 inches across the module board between respective first tier transmission lines.

Additionally, per a specific exemplary embodiment, the input impedance of buffer 231 may comprise a high termination impedance and of light capacitance, wherein the high input impedance presents nominal loading to (and with respect to) the transmission lines 242. In this embodiment, the input capacitance may be less that a few tens of picofarads. With the nominal loading of the buffer inputs and short lengths of taps 244, reflections and attenuations of the drops may be kept low so at to preserve an integrity of the overall transmission lines of the combined first and second tiers.

In a further embodiment, further referencing FIG. 2A, the first device to receive the clock signal of tap 244 comprises a memory chip having an input buffer to receive and generate a buffered signal corresponding to the clock signal received. The buffer may drive an on-board distribution circuit or transmission line circuit 240,261,262 . . . to propagate the buffered clock signal to other memory devices 231A, 233A . . . of the memory module. In this embodiment, a primary line 240 of the on-board transmission line circuit may extend beside each of the memory devices. Secondary taps 261,262 . . . may tap into the primary line to couple the buffered signal of the primary line to respective ones of the remainder of memory devices 232A, 232A . . . . Similarly as presented above relative to tap line 244, the lengths of taps 261,262 . . . may be kept short relative to an overall length of the primary line 240.

In accordance with a further aspect of exemplary embodiments of the present invention, a buffer of first device 231 may be further operable to limit the amount of extraneous noise that may travel in a reverse direction from on-board the memory module to the higher level transmission line circuit 250, 242A, 251A, 242B . . . that may reside external the memory module. In other words, a reverse isolation of the input buffers may serve to keep noise of the various memory modules from adversely impacting operations the other memory modules and, thus, may further preserve an integrity of the transmission line circuit for propagation of the system clock signal.

In some embodiments of the invention, the plurality of memory chips 231, 232, 233, etc. on each memory module 210 may be identical to one another. For example, each memory chip 231A, 232A, and 233A of memory module 210A may each include separate input and output buffering circuits. In the embodiment illustrated in FIG. 2A, both the input and output buffering circuits in the memory chip 231A are used to receive the system clock signal from the tap line 244A and to pass it to the primary line 240 and to the memory chip 232A. The memory chip 232A, however, does not necessarily need to have a clock circuit output buffer because the chip 232A only receives the clock signal but does not output the clock signal. One possibility is that the memory chips 232A and 231A are identical, but that the output buffer in the 232A memory is simply unused. Otherwise, specialty memory chips (not shown) could be used, where different memory chips may have different structures according to their functions on the memory module 210. For instance, the memory chip 231A may include both input and output buffers for the clock signals, but memory chip 231B only includes an input buffer for the clock signal, but no clock signal output buffer.

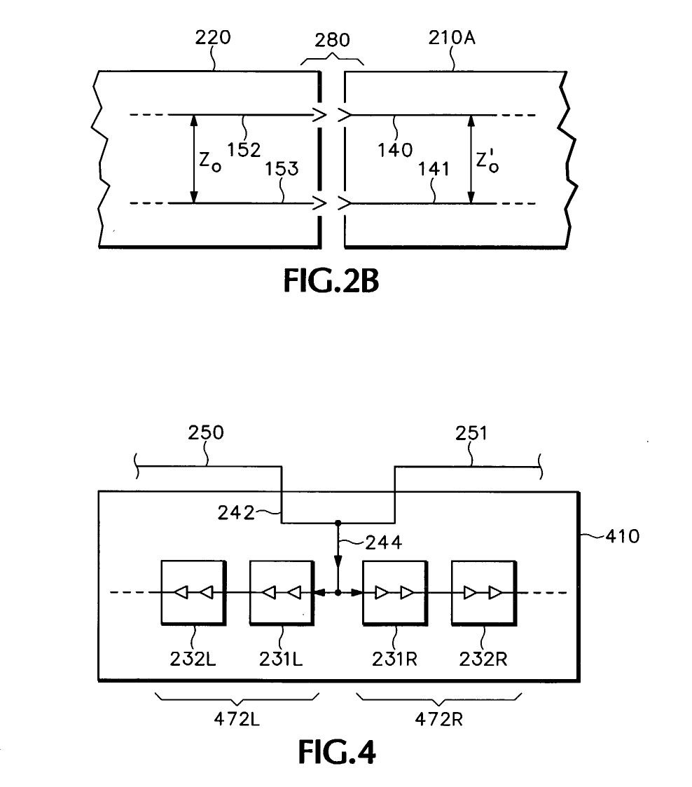

In accordance with another embodiment of the present invention, with reference to FIG. 3, system 300 comprises an architecture similar to the exemplary embodiment described above with reference to FIGS. 2A and 2B. In this embodiment, backplane 220 propagates a system clock signal from a clock generator 140 of, for example, a memory controller to a plurality of memory modules 310A, 310B . . . . Again, clock generator 140 may drive first link 250 of the first tier of transmission lines disposed on backplane 220. The transmission lines of a second tier reside onboard memory modules 310A, 310B. . . . and between links of the first tier. Accordingly the transmission lines 250, 251A, 251B . . . of the first tier and transmission lines 242A, 242B . . . of the second tier are disposed in alternate and serial arrangements with respect to each other.

In this embodiment of FIG. 3, however, the internal distribution circuits of the memory modules 310 differ from those of the previous embodiment described above relative to FIG. 2A. In this embodiment of FIG. 3, each memory device of a plurality 231A, 232A, 233A . . . of memory module 310 may comprise a buffer circuit that receives a clock signal and buffers it to an output for driving the next memory device of their serial sequence. For example, a first memory device 231A of memory module 310 may receive a clock signal from tap line 244A and may buffer the clock signal received for further distribution to second memory device 232A via inter-coupling transmission line 361A. Likewise, second memory device 232A may comprise a buffer to receive the clock signal of line 361A and may buffer it to an output for further distribution along line 362A to third memory device 233A. In this embodiment, each of the memory devices comprise a buffer to receive a clock signal of a preceding device and may buffer the signal received for further distribution sequentially and serially to the remaining memory devices of the memory module 310A.

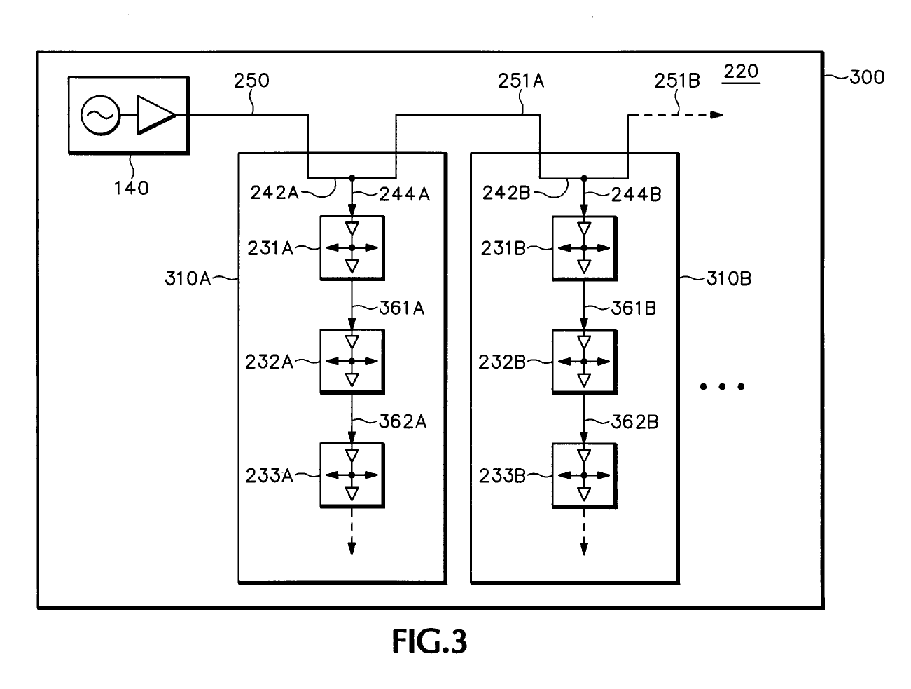

In accordance with another embodiment of the present invention, each of the memory modules 310 for the system of FIG. 3 may be replaced with an alternative memory module 410 as illustrated in FIG. 4. In this alternative embodiment, second tier transmission lines 242 couple between two neighboring respective links of the first tier, e.g., 250, 251. Again, the second tier lines reside onboard memory modules 410. A tap line 244 may couple into the second tier transmission line 242 near a mid-region of the module. The tap line may supply a clock signal to a first memory device in each of first and second groups of memory devices 472L and 472R of memory module 410. In one embodiment, the first and second groups 472L and 472R of memory devices may be disposed on respective left and right halves of the memory module.

Continuing with further reference to FIG.4, in this embodiment, the input loading of first memory devices 231L and 231R may comprise high termination impedance levels and light capacitance so as to present a nominal impact by their tap presentments to the overall transmission line of the first and second tiers. Buffers of the respective memory modules 231L and 231R receive the clock signal from tap line 244 and provide buffered outputs to subsequent respective memory devices 232L and 232R of the left and right sequentially arranged groups 472L, 472R of memory devices of memory module 410. In this embodiment, it will be noted that the tap line couples into the system line near the middle region of memory module 410. The distribution circuit may then distribute the clock signal outwardly from the middle region of the memory module to the memory devices of the respective left and right side sequential groups.

For this embodiment, it may be understood that as the clock signal passes through each buffer, it may accumulate jitter. However by, distributing the clock signal from a center point and outwardly to respective left and right groups, the resulting accumulated jitter of the clock signal upon arrival at an end memory device may be less than the amount of jitter which might otherwise accrue if the clock signal were to propagated through the entire sequence of the memory devices of the a memory module, i.e., starting from one end of the memory module and propagating to the other end.

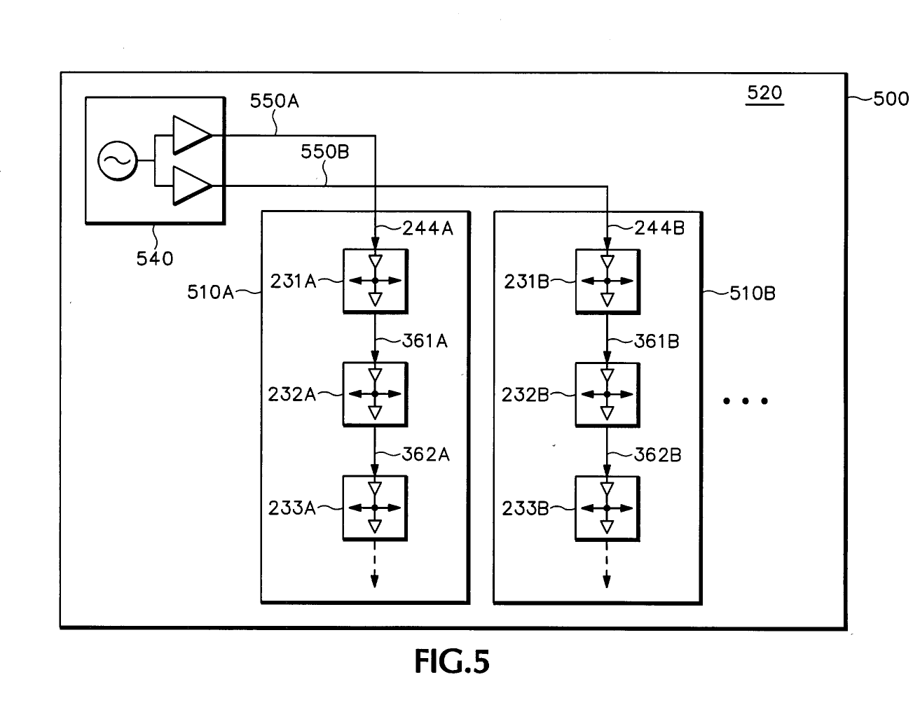

In accordance in another embodiment of the present invention, with reference to FIG. 5, system 400 comprises a generator source 440 of, for example, a memory controller, which may provide a clock signal to a plurality outputs. Different system transmission lines 450A, 450B . . . of a backplane 420 may distribute the individual clock signals separately from the generator outputs to different respective memory modules 310A, 310B . . . of the system. On-board the memory devices 310, the arrangement of memory chips and distribution transmission lines may correspond similarly to modules described previously herein relative to FIG.3, but absent their on-board, second tier inter-coupling transmission line 242. Accordingly, in this embodiment of FIG. 5, input tap 244A of memory module 510A receives the clock signal directly from system line 550A. Similar to the embodiment described above relative to FIG. 3, the plurality of memory chips 231A, 232A, 233A . . . may comprise buffers to buffer clock signals for driving the next sequential memory devices of their sequence.

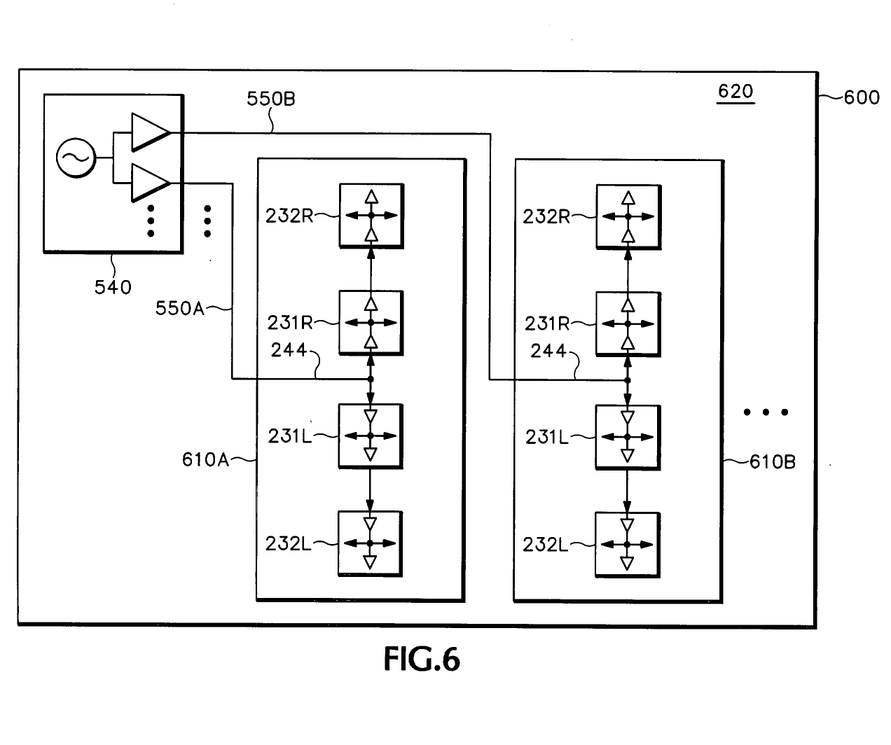

In accordance with a further embodiment of the present invention, with reference to FIG. 6, system 600 comprises an architecture similar to that of FIG. 5. But in this embodiment of FIG. 6, memory modules receive a clock signal at a middle region of the module and distribute the clock signal outwardly from the middle region to respective left and right sequential groups of memory devices. As presented before with reference to FIG. 4, a system clock line may be distributed the system clock signal to a middle region of memory modules 610. The clock signal may then be distributed outwardly and sequentially through the memory devices of the respective halves of the memory module. In this embodiment, further referencing FIG. 6, tap line 244 of memory module 610A may receive a clock signal from external system line 550 for distributing the clock signal to a middle region of the memory module. The clock signal may then be coupled to first memory devices of respective right and left sequential groups. The memory devices may each comprise a buffer that receive the clock signal and buffer the signal to drive adjacent memory devices within the respective first and second sequential groups of memory devices of the memory module.

In accordance with further embodiments, the lengths of the system lines 550A, 550B . . . to respective memory modules may be substantially the same to provide similar propagation delays from generator 540 to the different memory modules. Alternatively, predetermined delays may be configured within the different output channels of generator 540 for offsetting or compensating propagation differences between the separate transmission lines 550 of the backplane.

It will be apparent to those skilled in this art that the illustrated embodiments are exemplary and that various changes and modifications may be made thereto as become apparent upon reading the present disclosure. Accordingly, such changes and modifications are considered to fall within the scope of the appended claims.

What is claimed is:

1. A system for propagating a signal, comprising:
a plurality of modules; and
a backplane to propagate signals to the plurality of modules, the backplane including a first clock line structured to propagate a clock signal to a first module of the plurality of modules, and including a second clock line structured to propagate a clock signal between the first module and a second module of the plurality of modules;
wherein the first module includes a transmission line structured to propagate the clock signal from the first clock line to the second clock line.

2. The system according to claim 1 wherein the first module further comprises:
a plurality of devices to receive the clock signal; and
a buffer to receive the clock signal from the transmission line, the buffer further operable to amplify the clock signal received and output the amplified clock signal for the plurality of devices.

3. The system according to claim 2, wherein the first module further includes a tap line positioned between the transmission line and the buffer, the tap line structured to receive a portion of the clock signal of the transmission line and to propagate the received portion to the buffer.

4. The system according to claim 3 wherein the first module further includes first and second launches at respective ends of the transmission line to transition to/from the transmission line of the first module from/to respective first and second clock lines of the backplane, each launch comprising a signal conductor and at least one signal return conductor adjacent the signal conductor.

5. The system according to claim 4, wherein the first and second transmission lines have characteristic impedances between about 30 ohms and 100 ohms.

6. The system according to claim 5 wherein the transmission line of the first module has a characteristic impedance between about 30 ohms and 100 ohms.

7. The system according to claim 5, wherein the buffer has an input impedance greater than the characteristic impedance of the transmission line of the first module, and wherein the tap line has a length less than the length of the transmission line on the first module.

8. The system according to claim 1, further comprising a clock source structured to drive the first clock line of the backplane.

9. The system according to claim 8, wherein the clock source is a clock generator on a memory controller.

10. The system according to claim 1 wherein the plurality of modules are memory modules.

11. The system according to claim 10 wherein the memory modules are Dual In-line Memory Modules (DIMMs) each having a plurality of synchronous memory chips to receive clock signals for synchronous operation.

12. A system for propagating signals comprising:
a motherboard adapted to interface with a plurality of memory modules;
a first line of the mother board structured to propagate a clock signal from a clock source to a first memory module of the plurality;
a second line of the mother board structured to propagate a clock signal from the first memory module to a second memory module of the plurality;
a transmission line of the first memory module coupled between the first line and the second line;
a tap line of the first memory module operable to obtain a portion of the clock signal propagated by the transmission line; and
a memory device of the first memory module to receive the clock signal from the tap line.

13. The system according to claim 12 wherein the first memory module further comprises a buffer structured to amplify the signal obtained from the tap line to provide a buffered clock signal, and structured to drive the memory device with the buffered clock signal.

14. The system according to claim 13 wherein the first memory module further comprises a second memory device, and wherein the buffer is also structured to drive the second memory device with the buffered clock signal.

15. The system according to claim 14 wherein the first memory module further comprises a propagation line structured to propagate the buffered clock signal from the buffer to each of the memory devices of the memory module.

16. The system according to claim 12 wherein the first memory module further comprises a plurality of chips, one of the plurality of chips including the memory device;
a first chip of the plurality of chips structured to receive the clock signal directly from the tap line, the first chip structured to output a clock signal corresponding to the clock signal received; and
a second chip of the plurality of chips structured to receive the clock signal output from the first chip.

17. The system according to claim 12 wherein the first memory module further comprises:
a plurality of memory chips separated into first and second groups disposed on respective first and second halves of a module board;
a buffer structured to amplify the clock signal from the tap line and to provide a buffered clock signal;
a transmission line circuit structured to route the buffered clock signal to a central location of the module board between the first and second groups of the plurality of memory chips; and
first and second distribution lines structured to receive the buffered clock signal from the transmission line circuit and to distribute the buffered clock signal outwardly from the central location of the module board to the memory chips of the respective first and second groups across the first and second halves of the module board.

18. The system according to claim 17, further comprising a memory controller having a clock source to drive the first line of the motherboard.

19. A computer system comprising:
a plurality of memory modules;
a memory controller having a clock to generate clock signals to the plurality of memory modules;
a transmission line circuit structured to route clock signals from the memory controller to each of the plurality of memory modules, and including, for each memory module of the plurality, a separate clock line structured to route respective clock signals thereto;
wherein each memory module includes:
a plurality of memory devices, and
a buffer to receive the clock signal from its respective clock line and to buffer the clock signal received for distribution to the plurality of memory devices.

20. The computer system according to claim 19 wherein a memory module of the plurality further comprises a transmission line circuit to distribute the buffered clock signal from the buffer to the plurality of memory devices.

21. The computer system according to claim 20 wherein the transmission line circuit comprises:
a primary line that extends with a length across the plurality of memory devices; and
tap lines to respective memory devices of the plurality to couple respective memory devices to the primary line.

22. The computer system according to claim 21 wherein the transmission line circuit comprises:
sequential link lines disposed serially along a module board to couple between respective neighboring memory devices of the plurality;
a first memory device of the serial sequence of the plurality to receive the buffered clock signal from the buffer; and
a second memory device of the serial sequence of the plurality to receive the buffered clock signal via the first memory device and one of the sequential link lines.

23. The computer system according to claim 22, in which each memory device is to receive an input clock signal and be operable to output an output clock signal corresponding to the received clock signal, the output to drive another link in the serial sequence of the transmission line circuit.

24. The computer system according to claim 23, further comprising a termination coupled to an end of a last link in the serial sequence of the transmission line circuit to terminate a clock output of a last memory device.

25. A computer system according to claim 21 wherein the transmission line circuit comprises:
a buffer output line structured to propagate the buffered clock signal to a mid-region of the memory module between first and second groups of memory devices of the plurality; and
first and second distribution lines to receive the buffered clock signal from the buffer output line at the mid-region and to distribute the buffered clock signal outwardly from the mid-region to respective memory devices of the first and second groups.

26. A method for distributing a clock signal to a plurality of memory modules, comprising:
propagating the clock signal on first and second tiers of transmission lines;
linking in alternating and sequential arrangement the transmission lines of the first tier with respective transmission lines of the second tier; and
propagating the clock signal of the second tier of transmission lines through respective memory modules associated therewith.

27. The method of claim 26 further comprising tapping each transmission line of the second tier to drive the memory devices of the memory modules.

28. A method according to claim 27 wherein tapping comprises propagating a signal obtained from a transmission line of the second tier along a stub length less than the length of the respective second tier transmission line.

29. The method according to claim 27, further comprising buffering clock signals of the tap lines before driving the memory devices of the respective memory modules.

30. A method of distributing a clock signal, comprising:
propagating clock signals from a memory controller to a plurality of memory modules;
receiving the clock signals near mid-regions of respective memory modules; and
distributing the clock signals received outwardly from the mid-regions of the respective memory modules to drive the memory devices of first and second halves of the respective memory modules.

31. The method of claim 30, further comprising buffering the clock signal received on the memory module before distributing the clock signals.

32. The method of claim 31, further comprising propagating the clock signal sequentially and serially through the respective memory devices of the first and second halves.

33. The method of distributing a clock signal according to claim 30, further comprising generating the clock signal with a memory controller.
